(19) United States
(12) Patent Application Publication
(10) Pub. No.: US 2009/0282238 A1
(43) Pub. Date: Nov. 12, 2009

(54) Secure handoff in a wireless local area network

(76) Inventors: Guillaume Bichot, La Chaussee (FR); Junbiao Zhang, Beijing (CN); Saurabh Mathur, Plainsboro, NJ (US)

Correspondence Address: Thomson Licensing LLC, P.O. Box 5312, Two Independence Way, PRINCETON, NJ, 08543-5312, US

(21) Appl. No.: 11/919,279

(22) PCT Filed: May 16, 2005
(86) PCT No.: PCT/US2005/017129

§ 371 Date: Oct. 25, 2007

(51) Int. Cl. G06F 21/00; H04L 9/08

(52) U.S. Cl. 713/155; 380/279; 380/270

(57) ABSTRACT

A system and method including computing keying information by a server for authentication of devices accessing a wireless local area network and forwarding the keying information by the server to access points included in a security domain of the wireless local area network, wherein one of the access points is associated with a mobile device are described.

### FIELD OF THE INVENTION

The present invention relates to authentication of user equipment in a wireless local area network. In particular, the present invention relates to a fast secure handoff mechanism for user equipment in a wireless local area network.

### BACKGROUND OF THE INVENTION

Advancements in wireless local area network (WLAN) technology have resulted in the publicly accessible hot spots at rest stops, cafes, airports, libraries and similar public facilities. Presently, public WLANs offer mobile communication device (client) users access to a private data network, such as a corporate intranet, or a public data network such as the Internet, peer-to-peer communication and live wireless TV broadcasting. The relatively low cost to implement and operate a public WLAN, as well as the available high bandwidth (usually in excess of 10 Megabits/second) makes the public WLAN an ideal access mechanism through which mobile wireless communications device users can exchange packets with an external entity.

Security is improving in wireless local area networks. The adoption of standards like IEEE 802.1x remote authentication provides flexibility, scalability and more security. Basically the mobile device that associates with an access point has to be authenticated before being able to transmit/receive data. The authentication process is triggered by the access point but is indeed managed between the user equipment and a remote server called an authentication, authorization and accounting (AAA) server (also called “authentication server”). Once the mobile station/user equipment is authenticated the AAA server communicates with the access point to grant the mobile device access and to deliver ciphering keys.

These standards have not, however, been written with wireless networks in mind. The consequence of this is that when a mobile station handoff (i.e., moves from one area covered by an access point to another area covered by another access point) occurs, the mobile station has to proceed again with the entire authentication process.

There is a sub-group within the IEEE 802.11 working group that is working on an inter-access point protocol. The idea underlying this protocol is that when the mobile station handoff occurs between two access points, the inter-access point protocol allows then two access points to communicate the mobile station/user equipment context data as well as packet data which would have been lost otherwise. This protocol can be used to communicate some information relative to authentication. The problem is that the protocol involves only two access points—the two access points involved in the current handoff. Thus, each time the mobile station is handed-off between two access points, a full authentication is required.

When a mobile user roams into a hotspot network, it may be necessary for the hotspot network and the user's service provider network to carry out a roaming protocol to authenticate the user and grant user access. More particularly, when a user attempts to access service within a public WLAN coverage area, the WLAN first authenticates and authorizes the user, prior to granting network access. After authentication, the public WLAN opens a secure data channel to the mobile communications device to protect the privacy of data passing between the WLAN and the device. Presently, many manufacturers of WLAN equipment have adopted the IEEE 802.1x standard for deployed equipment. Hence, this standard is the predominant authentication mechanism utilized by WLANs. Unfortunately, the IEEE 802.1x standard was designed with private LAN access as its usage model. Hence, the IEEE 802.1x standard does not provide certain features that would improve the security in a public WLAN environment.

In a web browser based authentication method, the mobile terminal (MT) directly authenticates with the AAA server (AS), using the web browser through a Hyper Text Transfer Protocol Secured Sockets (HTTPS) protocol and ensures that the access point (AP) (and any other device/component on the path between the MT and the AS) cannot trespass upon or steal confidential user information. While the channel is secure, the AP cannot determine the result of the authentication unless explicitly notified by the AS. However, the only information the AS has related to the MT is its Internet protocol or IP address at the other end of the HTTPS session. When firewalls, Network Address Translation (NAT) servers, or web proxies are electronically situated between the AS and the MT, which is normally the case with a virtual operator configuration, it is difficult or even impossible for the AS to initiate a session to notify the AP about the result of the authentication and to identify the MT.

Most existing WLAN hot spot wireless providers use a web browser based solution for user authentication and access control, which proves convenient to the user and does not require any software download on the user device. In such a solution, the user is securely authenticated through HTTPS by a server, which in turn notifies the wireless AP to grant access to the user. Such an authentication server AS may be owned by the WLAN operator or any third party providers, such as Independent Service Providers (ISPs), pre-paid card providers or cellular operators, referred to more broadly as virtual operators.

In the prior art, the authentication is achieved through a communication between the user and the authentication server, through a secure tunnel. As such the AP does not translate the communication between the user and the authentication server. Consequently, a separate communication referred to as authorization information between the AP and the authentication server AS must be established so that the AP is notified of the authorization information.

Access control in the AP is based on the address of the mobile communications device/client device, where the addresses may be physical addresses (PHY), media access control (MAC) addresses or internet protocol (P) addresses, and therefore, the authentication server can use the mobile terminal MT IP address (the source address of the HTTPS tunnel) as the identifier when it returns the authentication result to the AP. This approach succeeds, if neither a firewall nor a NAT between the AP and the authentication server AS exists. The source address that the authentication server receives would be the web proxy's address, which cannot be used to identify the mobile terminal user device and, therefore, cannot be used by the AP in assuring a secure connection.

What is needed is a mechanism for improving the speed for handoffs in a wireless local area network without compromising security.

### SUMMARY OF THE INVENTION

The context of the present invention is the family of wireless local area networks employing the IEEE 802.1x architecture having an access point that provides access for mobile communications devices (also called “clients” or “client devices” or “user equipment” or “mobile stations” or “mobile terminals”) and to other networks, such as hard wired local area and global networks, such as the Internet. The present invention provides a fast smooth handoff mechanism without compromising security. The mobile station/user equipment, having been authenticated at least once, can be handed-off without the need for re-authentication. The present invention is a mechanism that includes broadcasting the keying material by an authentication server to a set of access point under its security scope (or security domain). In such a manner, the mobile station/client can smoothly be handed-off between access points. Although the present invention uses the IEEE 802.11 radio protocol as the working assumption, the mechanism of the present invention is applicable to any infrastructure wireless local area network whatever the radio technology. Infrastructure includes any traffic from/to a mobile station. This usually is within the context of a client-server model and usually involves traffic going through an access point.

A system and method including computing keying information by a server for authentication of devices accessing a wireless local area network and forwarding the keying information by the server to access points included in a security domain of the wireless local area network, wherein one of the access points is associated with a mobile device are described.

### BRIEF DESCRIPTION OF THE DRAWINGS

The present invention is best understood from the following detailed description when read in conjunction with the accompanying drawings. The drawings include the following figures briefly described below:

FIG. 1 is a typical prior art configuration for remote authentication.

FIG. 2 depicts the distribution/broadcasting of keying material to all access points in accordance with the present invention.

FIG. 3 depicts the distribution/broadcasting of keying material by an access point in accordance with the present invention.

FIG. 4 is a ladder diagram indicating the flow of messages between the mobile terminal, the access points and the authentication, authorization and accounting (AAA) server in accordance with the present invention.

### DETAILED DESCRIPTION OF THE PREFERRED EMBODIMENTS

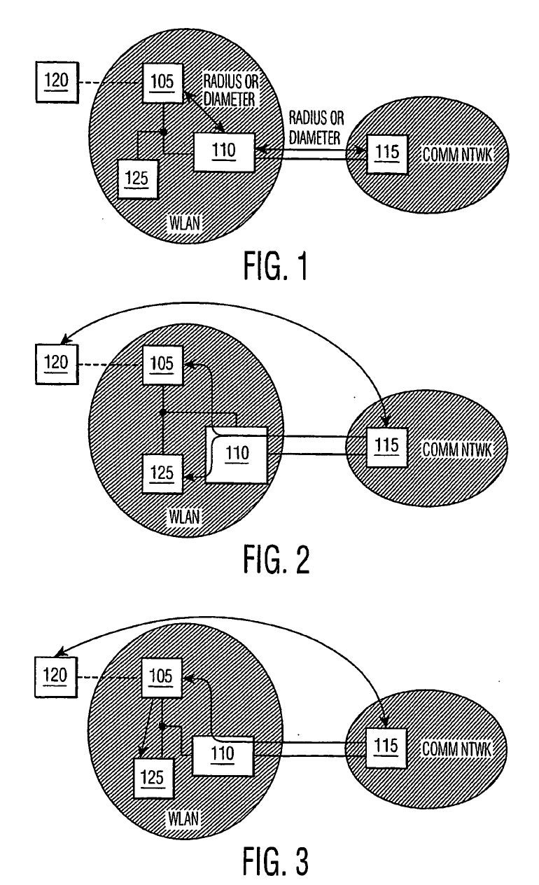

FIG. 1 is a typical prior art configuration for remote authentication. The mobile station/client device associates with access point 1 105. The access point has established a DIAMETER/RADIUS connection with the remote AAA server 115 through a so-called AAA proxy server 110. This AAA proxy server 110 is strictly not required but practically is extremely helpful. It allows the access point 110 associated with the mobile station 120 to be configured with one AAA server address only—the address of the AAA proxy server 110. Consequently, only one RADIUS/DIAMETER connection is required between the AP associated with the mobile station and the AAA proxy server. The AAA proxy server manages several connections with several AAA servers.

The authentication exchange takes place between the user equipment/client device 120 and the remote AAA server 115 via extended authentication protocol (EAP). EAP messages are transported transparently through the AP 105 associated with the mobile station 120 within a dedicated RADIUS/DIAMETER message. Once authenticated, the AAA server 115 configures access point 1 105 through the AAA proxy server 110 (if it exists) using the DIAMETER/RADIUS protocol. The AAA server 115 signals to the AP 105 that the mobile station/client device 120 is granted access (for example, the mobile station can transmit and receive data packets and reach the Internet). The AAA server 115 also transmits keying material to access point 1 105 used by access point 1 105 to encrypt the data packet going to/coming from the mobile station (MS)/mobile terminal (MT) 120. At this point the authentication server has already delivered the keying material through the authentication process to the mobile station 120. This remote authentication process is quite time consuming and involved and needs to be performed each time the mobile station associates or re-associates with an access point. Regarding FIG. 1, if MT 120 moves in sight of access point 2 125 for a handoff and becomes associated with access point 2 125, it has to again perform the authentication process.

In the present invention, after the AAA server 115 has computed the keying material for the new session involving the MT 120, it sends the keying material not only to the access point 105 with which the MT 120 is associated (access point 1 105 in FIG. 2) but to all APs that are under the security scope of the AAA server 115. The security scope of the AAA server 115 is a configuration parameter that includes splitting a set of access points into different security domains in order to enhance the security and management of the wireless local area network. A small wireless local area network consisting of a couple of access points would have only one security domain or security scope. A large wireless local area network consisting of a number of access points could have a number of security domains or security scopes. Security domains may overlap.

The keying material corresponds to a session key, the identification of the MT (for example, the MAC address of the MT) and the domain name of the AAA server (a MT may be engaged in several sessions in parallel with different AAA servers but via a single AP). Each access point receiving the message containing the session key updates its internal security table with the MAC address of the MT, the AAA domain name and the corresponding session key.

When the mobile terminal is handed off to another access point in the same security domain/security scope, it is associated with the access point as in the previous scenario. However, the new AP checks its internal security table and locates an entry in the internal security table that matches the MAC address of the MT. The access point can then read the corresponding session key and derive the ciphering/deciphering key for the MT.

The manner is which the mobile station detects that no authentication is necessary is linked to the wireless local area network radio technology. For example, in IEEE 802.11, IEEE 802.1x will probably be recommended. IEEE 802.1x defines a protocol over Ethernet extended authentication protocol over local area network (EAPOL). After being associated with an access point, the mobile station initiates an authentication process by sending an EAPOL-START packet. If no authentication is necessary the access point ignores the message.

The AAA server triggers authentication or re-authentication whenever it is necessary. When a new session key is computed it is sent to all access points. There are several ways to send the keying material from the AAA server to the access points, the keying material can be unicast, multicast or broadcast. The source address is the source address of the AAA proxy server (or the AAA server if there is no AAA proxy server) and the destination address is either the destination address of each access point for the unicast mode or an IP multicast group address dedicated to this usage or the destination addresses of all APs in the security domain/security scope. The unicast mode is the simplest solution since the RADIUS/DIAMETER client supports the unicast mode by default. Multicast and broadcast are convenient because they do not mandate that the AAA server knows the list of access points in advance. Multicast and broadcast, however, are not currently supported by DIAMETER.

The presence of an AAA proxy server simplifies the implementation when the AAA server is outside of the wireless local area network domain as depicted in FIG. 2. Without the AAA proxy server, it is the responsibility of the AAA server to send the keying material to the access points requiring the keying material. With the AAA proxy server, the AAA server sends the keying material to the AAA proxy server and the AAA proxy server is responsible for forwarding the keying material plus the identification of the AAA server domain and the identification of the MT to all other access points within the security domain/security scope.

FIG. 3 depicts another embodiment of the present invention. After authentication is performed (see step 1) keying information/material is passed to the access point (access point 1 105 in FIG. 3) associated with the authenticated MT 120 (see step 2). In this embodiment of the present invention the AAA functions (server or proxy) are transparent regarding the distribution of the keying material. Once the access point 105 (access point 1 105 in FIG. 3) associated with the authenticated mobile station is configured, it forwards the keying material to other access points (see step 3) using broadcast (if possible), multicast (if possible) or unicast network means. Broadcast or multicast are preferable because the source access point need not know the list of access points present in the wireless local area network in advance.

It is possible that an access point has not been configured when a mobile station is handed-off such that the AP does not have up-to-date keying material regarding a particular mobile station. The access point detects this condition by being unable to decrypt a packet coming from that mobile terminal. In this instance the access point triggers full authentication.

The access point cannot permanently store keying records. A time-to-live (TTL) is associated with the keying material. Once the TTL expires, the access point removes the record from memory. The TTL is implemented as a timer, which may be extended/increased with each access.

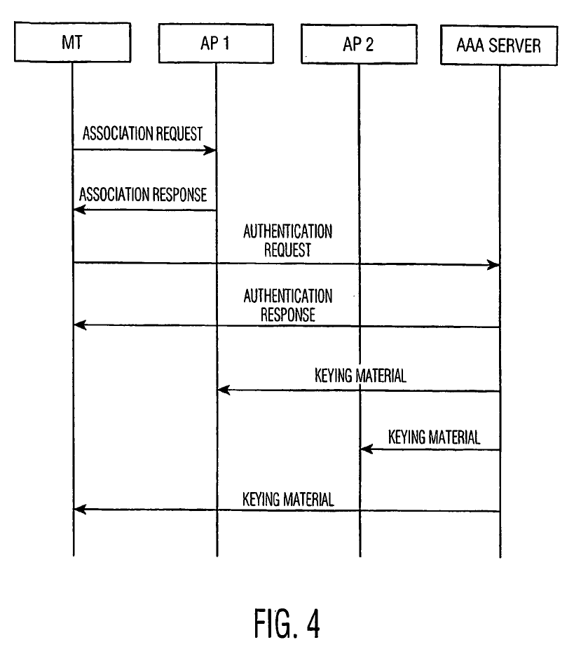

FIG. 4 is a ladder diagram indicating the flow of messages between the mobile terminal, the access points and the authentication, authorization and accounting (AAA) server in accordance with the present invention. FIG. 4 shows one embodiment for the distribution of the keying material by the AAA server. This figure is only meant to elucidate one possible keying material distribution mechanism. In an actual implementation, some of the steps may be combined together or removed for efficiency or other reasons.

In FIG. 4, the MT associates itself with AP 1 via association request 405. API responds to MT with association response 410. MT authenticates itself to the AAA server via authentication request 415. AAA server authenticates MT via authentication response 420. The AAA server sends the keying material (435, 425, 430) to the MT, AP 1 as well as AP 2. If the MT associates with AP 2, AP 2 would already have the keying material for that MT in its cache (this assumes that the MT associates with AP 2 before the expiration of the cache entry at AP 2 for the MT). In this case, the MT would not have to undergo the authentication procedure again.

It is to be understood that the present invention may be implemented in various forms of hardware, software, firmware, special purpose processors, or a combination thereof, for example, within a mobile terminal, access point, or a cellular network. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method comprising:
computing keying information by a server for authentication of devices accessing a wireless network; and
forwarding said keying information by said server to access points included in a security domain of said wireless network, wherein one of said access points is associated with a mobile device.

2. The method according to claim 1, further comprising:
establishing by said mobile device communication with said one of said access points associated with said mobile device;
establishing a connection between said server and said one of said access points associated with said mobile device; and
authenticating said mobile device by said server.

3. The method according to claim 2, wherein said connection is via a proxy server.

4. The method according to claim 2, wherein said connection is established using RADIUS/DIAMETER protocol.

5. The method according to claim 1, wherein said forwarding step further comprises forwarding said keying information to a proxy server and said proxy server forwards said keying information to said access points in said security domain.

6. The method according to claim 1, wherein said keying information includes an identification of said mobile device, a domain name of said server and a session key.

7. The method according to claim 1, wherein said server is an authentication, authorization and accounting server

8. A system comprising a server, wherein said server computes keying information and forwards said computed keying information to access points included in a security domain of a wireless network.

9. The system according to claim 8, wherein said mobile device is associated with one of said access points and further wherein said server authenticates said mobile device.

10. The system according to claim 8, wherein said server is an authentication, authorization and accounting server.

11. The system according to claim 9, wherein a connection is established between said one of said access points associated with said mobile device and said server.

12. The system according to claim 11, wherein said connection is through a proxy server.

13. The system according to claim 11, wherein said connection is established using RADIUS/DIAMETER protocol.

14. The system according to claim 8, wherein said keying information is forwarded by forwarding said keying information to a proxy server and said proxy server forwards said keying information to said access points included in said security domain.

15. The system according to claim 8, wherein said keying information includes an identification of said mobile device, a domain name of said and a session key.

16. The system according to claim 12, wherein said proxy server is an authentication, authorization and accounting proxy server.

17. The method according to claim 1, wherein said wireless network is a wireless local area network.

18. The system according to claim 8, wherein said wireless network is a wireless local area network.

19. A method comprising:
computing keying information by server for authentication of devices accessing a wireless network;
establishing communication by a mobile device between said mobile device and a first one of a plurality of access points;
establishing a connection between said server and said first one of said plurality of access points associated with said mobile device;
authenticating said mobile device by said server; and
forwarding said keying information by said server to said plurality of access points included in a security domain of said wireless network, wherein one of said access points is associated with a mobile device, and further wherein said mobile device communicates data with a second one of said plurality of access points without re-authentication.

20. A system comprising:
means for computing keying information by server for authentication of devices accessing a wireless network;
means for establishing communication by a mobile device between said mobile device and a first one of a plurality of access points;
means for establishing a connection between said server and said first one of said plurality of access points associated with said mobile device;
means for authenticating said mobile device by said server; and
means for forwarding said keying information by said server to said plurality of access points included in a security domain of said wireless network, wherein one of said access points is associated with a mobile device, and further wherein said mobile device communicates data with a second one of said plurality of access points without re-authentication.
